(19) United States
(12) Patent Application Publication
(10) Pub. No.: US 2007/0140143 A1
(43) Pub. Date: Jun. 21, 2007

(54) Communication device and method for managing a communication link in a network

(76) Inventor: John M. Harris, Chicago, IL (US)

Correspondence Address: MOTOROLA, INC., 1303 EAST ALGONQUIN ROAD, IL01/3RD, SCHAUMBURG, IL, 60196, US

(21) Appl. No.: 11/311,647

(22) Filed: Dec. 19, 2005

(51) Int. Cl. H04L 12/28

(52) U.S. Cl. 370/254; 709/223

(57) ABSTRACT

A communication device and a method for managing a communication link 108 are provided. The method includes establishing 402 the communication link between an originator communication device 102 and a target communication device 104. The method also includes suspending 408 at least a portion of the communication link when the amount time required to render the data buffered outside of the originator communication device, which is for the target communication device and is not yet rendered at the target communication device, becomes greater than a first predefined threshold, and the originator communication device has released the floor of the communication link.

### FIELD OF THE INVENTION

This invention relates in general to the field of communication, and in particular to managing a communication link between different communication devices.

### BACKGROUND

A communication link is used for transfer of data and control information between an originator communication device and a target communication device present in a communication network. Examples of a communication device include, but are not limited to, a mobile phone and a two-way radio. The communication link can be classified as a wired communication link and a wireless communication link. The wired communication link is analogous to a physical link established between two landline telephones. The wireless communication link can be either a peer-to-peer link or an indirect link. The indirect link can be established between the originator communication device and the target communication device via a cellular infrastructure. A push-to-talk (PTT) communication link is an example of the indirect communication link.

However, in both wired and wireless communication links, the link between the originator communication device and the target communication device is established for entire duration of a call. In other words, the link is maintained, irrespective of whether data is being transferred. This results in an unnecessary loading of link resources, such as channel bandwidth, and the like. Further, maintenance of the communication link in such circumstances results in unnecessary battery consumption of both the originator communication device and the target communication device.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates an exemplary environment, in accordance with an embodiment of the present invention.

FIG. 2 is a block diagram of an exemplary communication device capable of managing a communication link, in accordance with an embodiment of the present invention.

FIG. 3 is a block diagram of a channel manager capable of establishing and suspending at least a portion of the communication link, in accordance with an embodiment of the present invention.

FIG. 4 and FIG. 5 depict a flowchart illustrating a method for managing the communication link, in accordance with an embodiment of the present invention.

FIG. 6, FIG. 7 and FIG. 8 depict a flowchart illustrating a method for managing the communication link, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail the method for managing a communication link in a network, it should be observed that the present invention resides primarily in the method steps and components of the communication device, which are employed to manage a communication link in the network.

Accordingly, the method steps and apparatus components have been represented where appropriate by conventional symbols in the drawings, showing only those specific details that are pertinent to understanding the present invention, so as not to obscure the disclosure with details that will be readily apparent to those of ordinary skill in the art having the benefit of the description herein.

A method and a communication device for managing a communication link, is provided. The method includes establishing a communication link between an originator communication device and a target communication device. The method further includes suspending at least a portion of the communication link when the amount of time required to render the data buffered outside of the originator communication device, which is for the target communication device but is not yet rendered at the target communication device, becomes greater than a first predefined threshold and the originator communication device has released floor of the communication link.

A communication device for managing a communication link between the communication device and a target communication device is also provided. The communication device includes a processor capable of comparing the time required to render the data buffered outside of the originator communication device, which is for the target communication device and is not yet rendered at the target communication device with the first threshold and a second threshold. The communication device further includes a channel manager operatively coupled to the processor. The channel manager is capable of establishing the communication link and suspending at least a portion of the communication link.

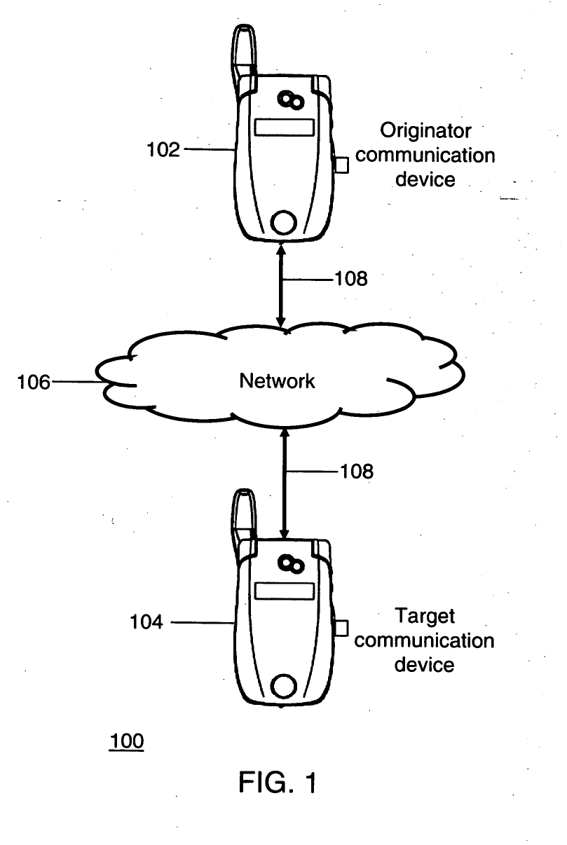

FIG. 1 illustrates an exemplary environment, in accordance with an embodiment of the present invention. Data is exchanged between an originator communication device 102 and a target communication device 104. The originator communication device 102 and the target communication device 104 are connected through a network 106. Examples of the network 106 include, but are not limited to, a mobile network, a Wi-Fi network, a WiMAX network, and the like. In an embodiment of the present invention, the network 106 includes a Push-To-Talk (PTT) server. The originator communication device 102 and the target communication device 104 are connected by using a communication link 108 on either side of the network 106. In an embodiment of the present invention, the communication link 108 between the originator communication device 102 and the target communication device 104 includes a first link between the originator communication device 102 and a cellular infrastructure and a second link between the cellular infrastructure and the target communication device 104. In such a case, the network 106 is replaced by the cellular infrastructure. Examples of the cellular infrastructure include, but are not limited to, a Base Transceiver System (BTS), a Radio Access Network (RAN), and the PTT server. In various embodiments of the present invention, the originator communication device 102 and the target communication device 104 are essentially similar and are differentiated only for exemplary purposes.

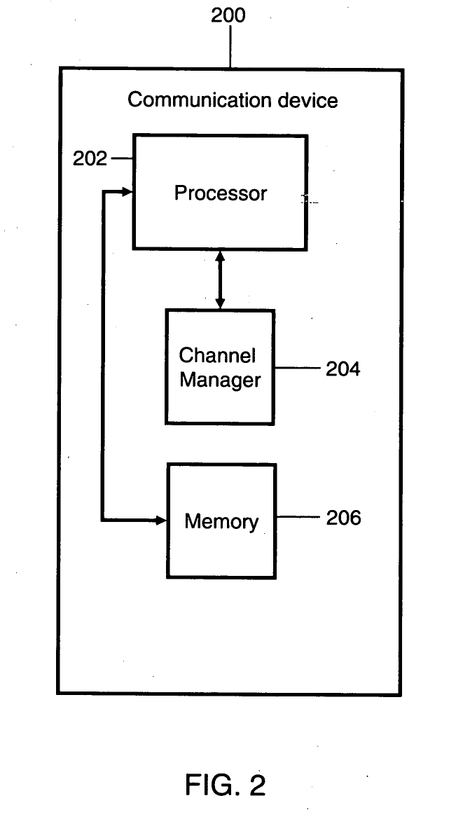

FIG. 2 is a block diagram of an exemplary communication device 200 capable of managing the communication link 108, in accordance with an embodiment of the present invention. The communication device 200, the originator communication device 102 and target communication device 104 are interchangeable and are differentiated only for the sake of clarity. The communication link 108 is used for transmission of data and control information between the communication device 200 and the target communication device 104. The transmitted data is buffered for the target communication device outside of the communication device 200. In an embodiment of the present invention, the data buffered is stored in the target communication device 104. In another embodiment of the present invention, the data buffered for the target communication device 104 is stored in the PTT server. The data buffered is for later use by the target communication device 104. For example, the target communication device 104 may not render the data at the same time as it is being transmitted by the communication device 200. Hence the data may be buffered outside of the communication device 200 for later use by the target communication device 104.

The communication device 200 includes a processor 202, a channel manager 204, and a memory 206. The processor 202 is capable of comparing the time required to render data buffered for the target communication device 104 with the first threshold and the second threshold. The first threshold is a link suspending threshold and the second threshold is a link re-establishing threshold. The processor 202 compares the amount of time required to render data buffered with the link suspending threshold before suspending at least a portion of the communication link 108. In an embodiment of the present invention, the communication link 108 between the originator communication device 102 and the network 106 is suspended. In another embodiment of the present invention, the communication link 108 between the target communication device 104 and the network 106 is suspended. The processor further compares the amount of time required to render the data buffered with the link re-establishing threshold. In an embodiment of the present invention, the portion of the communication link 108 suspended earlier is re-established. The communication link 108 remains suspended when the amount of time required to render the data buffered is between the link suspending threshold and the link re-establishing threshold.

The processor also has the additional functionality of checking whether floor of the communication link 108 has been released by the communication device 200. The floor of the communication link 108 gives the communication device 200 the control to transmit the data. In other words, a communication device possessing the floor is capable of transmitting the data. For example, as long as the communication device 200 has the floor of the communication link 108, only the communication device 200 can transmit the data. Similarly, when the target communication device 104 has the floor of the communication link 108, only the target communication device 104 can transmit the data. The functioning of the floor is similar to the functioning of a two-way radio. The data buffered is stored in the memory 206. In an embodiment of the present invention, the memory 206 is present in the PTT server. The channel manager 204 establishes and suspends at least a portion of the communication link 108. The channel manager 204 establishes and suspends at least a portion of the communication link 108 based on the comparisons made by the processor 202 with the link suspending threshold and the link re-establishing threshold.

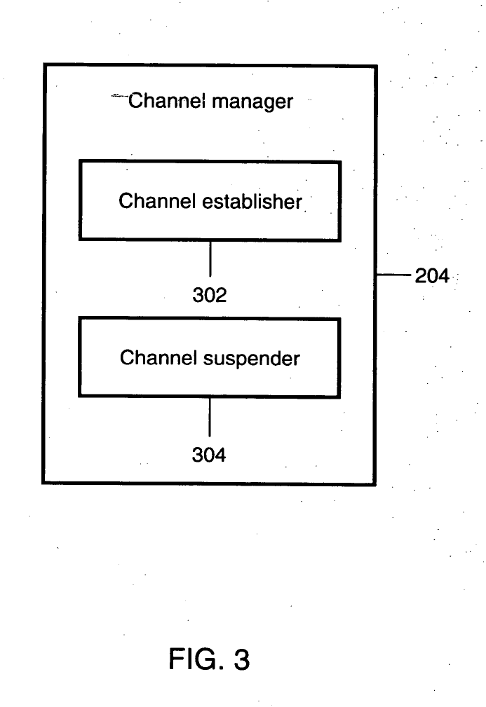

FIG. 3 is a block diagram of the channel manager 204 of the communication device 200 capable of establishing the communication link 108 and suspending at least a portion of the communication link 108. The channel manager 204 includes a channel establisher 302 for establishing the communication link 108. The channel manager 204 further comprises a channel suspender 304. The channel suspender 304 suspends at least a portion of the communication link 108 when the amount of time required to render the data buffered is greater than the first threshold and when the originator communication device 102 has released the floor of the communication link 108. In an example, the originator communication device 102 has a push button for holding the floor of the communication link 108. As long as a user of the originator communication device 102 has pressed the push button, the originator communication device 102 possesses the floor of the communication link 108 and only he/she can transmit data. The channel establisher 302 is further capable of re-establishing the communication link 108 when the amount of the time required to render the data buffered becomes less than the second threshold even when there is no new request for transferring data. The link is re-established so as to enable any future data transmissions from the originator communication device 102.

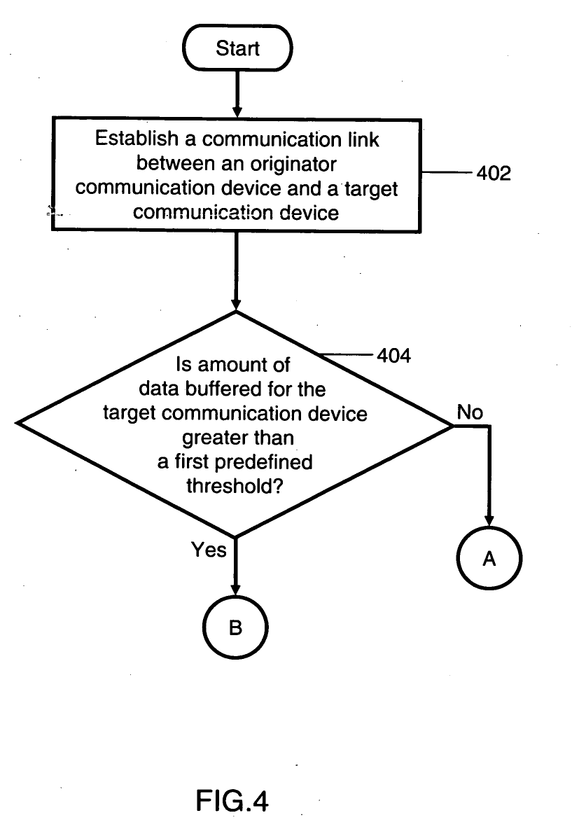

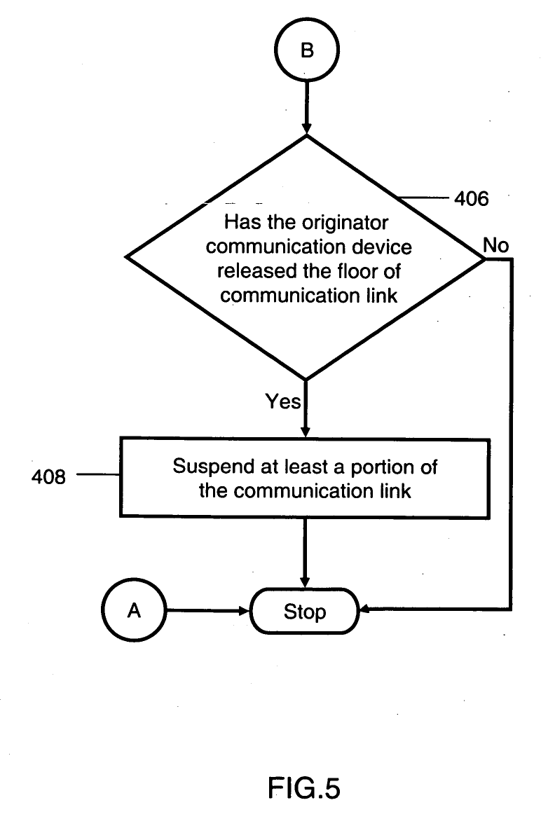

FIG. 4 and FIG. 5 depict a flowchart illustrating a method for managing the communication link 108, in accordance with an embodiment of the present invention. At step 402, the communication link 108 is established between the originator communication device 102 and the target communication device 104. In an embodiment of the present invention, the communication link 108 is established by the channel establisher 302. At step 404, a check is performed to determine whether the amount of time required to render the data buffered outside of the originator communication device 102 that is destined for the target communication device and is not yet rendered at the target communication device is greater than the first threshold. In an embodiment of the present invention, the check is performed by the processor 202. The first threshold is the link suspending threshold and is the maximum time required to completely play-out the buffered data at the target communication device 104. An example of the link suspending threshold is approximately eight seconds. In an embodiment of the present invention, the value of the first threshold is automatically adjusted to be greater than the sum of delay required to suspend the communication link and the delay required to re-establish the communication link. In yet another embodiment of the present invention, the link suspending threshold depends on fixed costs associated with establishing and suspending the communication link 108.

At step 406, a check is performed to determine whether the originator communication device 102 has released floor of the communication link 108 when the amount of time required to render data buffered is greater than the link suspending threshold. In an embodiment of the present invention, the check is performed by the processor 202. At step 408, at least a portion of the communication link 108 is suspended when the originator communication device 102 has released the floor of the communication link 108. In an embodiment of the present invention, suspending a portion of the communication link 108 includes dropping the first link. In another embodiment of the present invention, suspending a portion of the communication link 108 includes dropping the second link. In yet another embodiment of the present invention, suspending a portion of the communication link 108 includes dropping both the first link and the second link. In an embodiment of the present invention, at least a portion of the communication link 108 is suspended by the channel suspender 304. When the communication link 108 is suspended, then path for communication of data is incomplete between the originator communication device 102 and target communication device 104. Suspending the link includes breaking a traffic channel for data transmission but signaling channel and control channel still exist. Hence, the traffic channel can be allocated for some other purposes thereby saving bandwidth. Further, the control channel and signaling channel are used to resume the traffic channel whenever required.

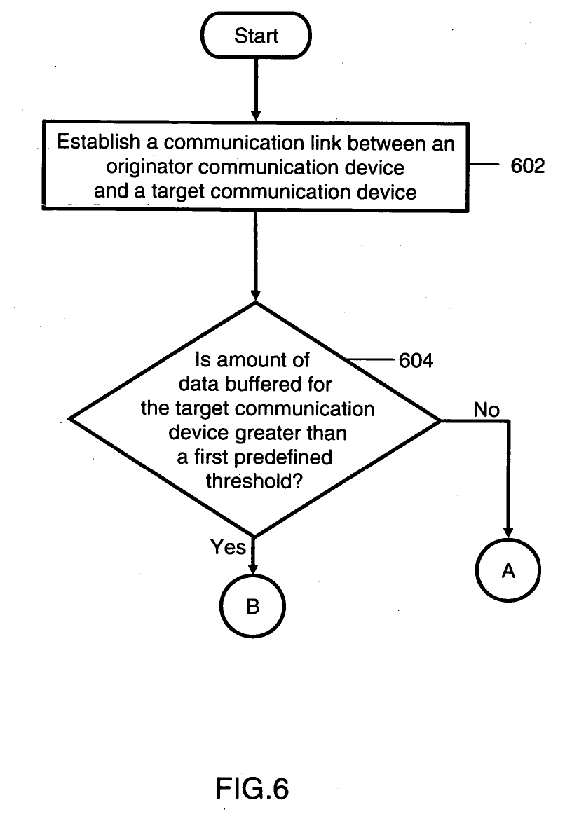

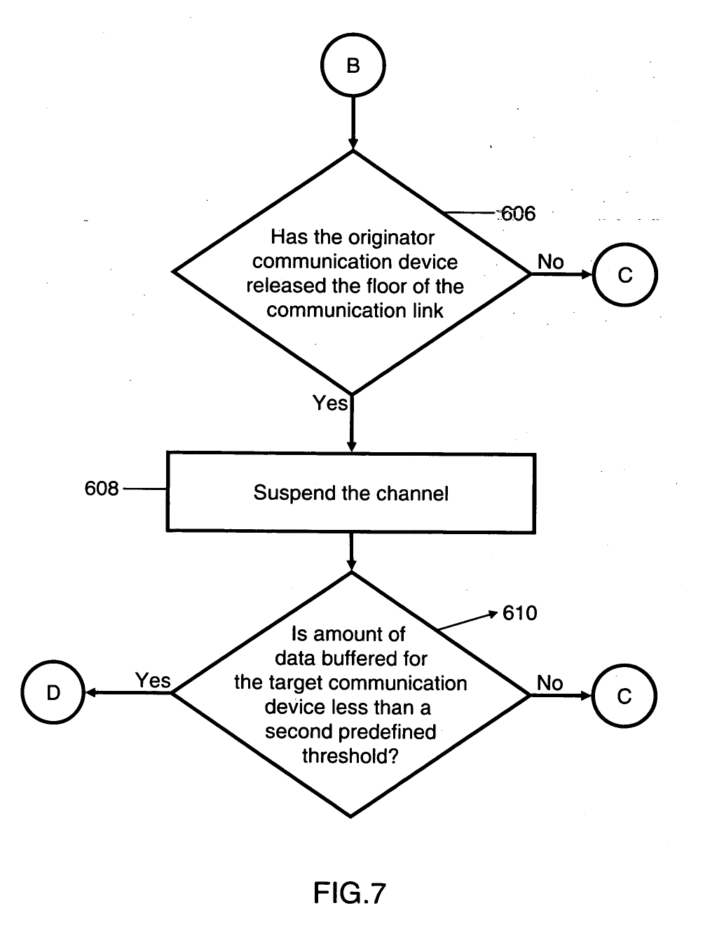

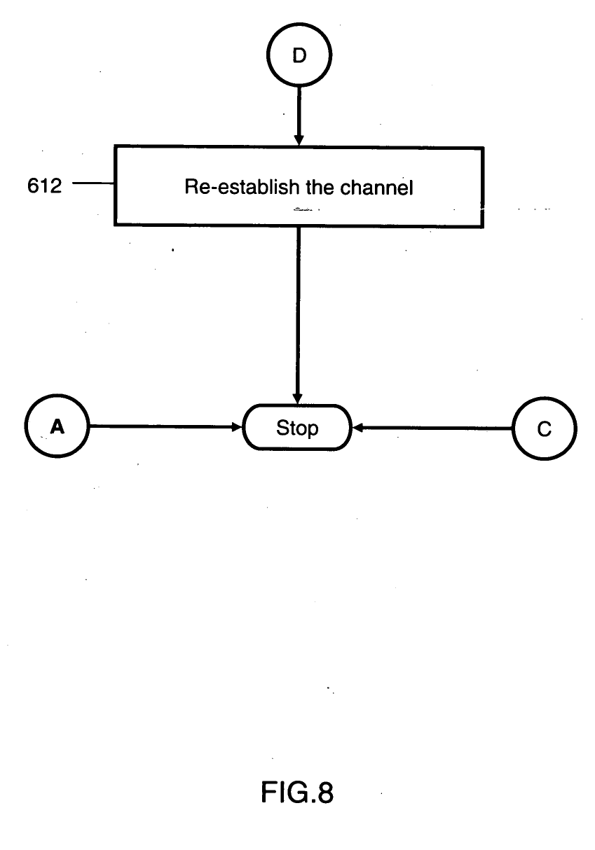

FIG. 6, FIG. 7 and FIG. 8 depict a flowchart illustrating a method for managing the communication link 108, in accordance with another embodiment of the present invention. At step 602, the communication link 108 is established between the originator communication device 102 and the target communication device 104. In an embodiment of the present invention, the communication link 108 is established by the channel establisher 302. At step 604, a check is performed whether the amount of time required to render the data buffered outside of the originator communication device 102 that is destined for the target communication device 104 and is not yet rendered at the target communication device is greater than the first threshold. In other words, the data buffered is stored in any other device in the network 106 except the originator communication device 102. In an embodiment of the present invention, the check is performed by the processor 202. The first threshold is the link suspending threshold. At step 606, a check is performed whether the originator communication device 102 has released the floor of the communication link 108 when the amount of time required to render the data buffered is greater than the link suspending threshold. In an embodiment of the present invention, the check is performed by the processor 202.

At step 608, at least a portion of the communication link 108 is suspended. In an embodiment of the present invention at least a portion of the communication link 108 is suspended by the channel suspender 304. In one embodiment of the present invention, a check is performed for the load on the network 106 before suspending the communication link 108. Other criteria taken into account while suspending the communication link 108 are Radio Frequency (RF) conditions and the battery life of both the originator communication device 102 and the target communication device 104. In another embodiment of the present invention, other criteria taken into account while suspending the communication link 108 include checking the RF conditions and the battery life of the target communication device 104. The communication link 108 is suspended when the RF conditions of either the originator communication device 102 or the target communication device 104 are poor. Further, the communication link 108 is suspended when the battery life of either the originator communication device 102 or the target communication device 104 is poor. In yet another embodiment of the present invention, the communication link is suspended based on an answering mode of the originator communication device 102 and the target communication device 104. The answering mode can be a manual answering mode or an automatic answering mode.

The first link (between the originator communication device 102 and the network 106) of the communication link 108 is dropped when the originator communication device 102 has completed uploading the content of last talk burst. The last talk burst is a last set of data buffered outside of the originator communication device 102. In other words, the last talk burst may be the last burst (or the last set) of the data sent by the originator communication device 102. In an embodiment of the present invention, the last talk burst is stored in another communication device which is in route between the originator communication device 102 the target communication device 104 and is listening to the originator communication device 102. In another embodiment of the present inventions, the last talk burst is stored in the cellular infrastructure. The last talk burst is initiated by the originator communication device 102 prior to releasing the floor by the originator communication device 102. Similarly, the second link (between the network 106 and the target communication device 104) of the communication link 108 is dropped when the target communication device 104 has completed downloading the content of talk burst. The content of the talk burst is the data buffered for the target communication device 104. The talk burst is initiated by the originator communication device 102 prior to releasing the floor by the originator communication device 102.

In another embodiment of the present invention, the signal strength of the first link is compared with a third RF threshold. The third threshold may be a minimum RF threshold. The first link is dropped when the signal strength of the first link is less than the minimum RF threshold. If the originator communication device 102 or the target communication device 104 is in poor RF conditions, then they consume unusually high amount of resources of the network 106. In an embodiment of the present invention, the value of the minimum RF threshold lies between −8 dB and −14 dB. The first link is suspended when the signal strength exceeds the minimum RF threshold. In such a case, the cost of the system to retain the channel despite the poor RF signals increases. Hence, the communication link 108 can be suspended even amidst an ongoing call.

In another embodiment of the present invention, another criterion checked before dropping the first link is remaining capacity within a sector of the cell site (or the cellular tower) providing RF coverage to the originator communication device 102. The remaining capacity of the sector is compared with a fourth threshold. The fourth threshold is channel capacity measured in Erlangs. In another embodiment of the present invention, the fourth threshold is expressed as a percentage of the total capacity of the sector. In case the remaining sector capacity exceeds the fourth threshold, then holding any communication device idling on that sector increases the cost for the system. Hence, the communication link 108 can be suspended even amidst the ongoing call. Suspending the communication link 108 even when a call is going on may be advantageous in some cases as described in detail earlier. Hence, the first link is dropped when the remaining capacity within the sector for the originator communication device 102 is less than a threshold.

The first link is dropped when the target communication device 104 is in at least one of the manual answer mode and the automatic answer override mode. The manual answer mode is the mode in which a conversation is started only after a user of the target communication device 104 manually accepts the request for a call. In another embodiment of the present invention, the first link is suspended when a user of the target communication device 104 has not pressed an accept button on the target communication device 104, to accept a request for an incoming call. The automatic answer override mode is a mode in which the automatic answer mode is manually overridden, and the target communication device is placed in the manual answer mode for that specific call. Manually answer mode is a call where the target will not begin rendering any media until the target presses an accept button on the target handset. Automatic answer mode describes a case where media may be rendered at the target without the target pressing an accept button on the target handset. Considering both the answering modes, the threshold in case of the manual answering mode is less than the threshold in the automatic answering mode. This is variation in the threshold accounts for the response time of a user of the target communication device 104 in case of the manual answering mode.

Further, the first link is dropped when the presence state of the target communication device 104 is shown as having a specific value for a specific presence attribute. For example, the presence state of the target communication device 104 can be shown busy, or unavailable. In an embodiment of the present invention, the presence state of the target communication device 104 is shown as busy when the target communication device 104 is in another call. In another example, the target communication device 104 is seen as unavailable when it is out of network coverage or is switched off. In yet another example, the target communication device 104 is seen as not to be disturbed when the user of the target communication device 104 is in a meeting.

Another example of the specific attribute is the location of the target communication device 104. For example, if the target communication device 104 is low on battery, then suspending the communication link 108 depends on the location of the target communication device 104. If a user of the target communication device 104 is in his/her office, then he/she can recharge the battery and hence there is no need to suspend the communication link 108. On the other hand if the user is outdoors, then there is a need to suspend the communication link 108 in case of a low battery. The first link is also dropped when the call history of the originator communication device 102, target communication device 104 and location of at least one of the originator communication device 102 and the target communication device 104 indicates that the target communication device 104 is unlikely to answer a call. The call history includes the response of the target communication device 104 to previous call attempts. For example, in case the call history indicates that the target communication device 104 has not responded to any previous calls, or is not going to answer any incoming request then the first link may be dropped even while a call is live.

In another embodiment of the present invention, the signal strength of the second link is compared with a fifth threshold. The fifth threshold is a minimum RF threshold. The first link is dropped when the signal strength of the second link is less than the minimum RF threshold. In another embodiment of the present invention, another criterion checked before dropping the second link is remaining capacity within a sector of the cell site or the cellular tower providing RF coverage to the target communication device 104. The remaining capacity of the sector is compared with a sixth threshold. The second link is dropped when the remaining capacity within the sector for the target communication device 104 is less than the sixth threshold. Further, the second link is dropped when the target communication device 104 is in at least one of the manual answer mode and the automatic answer override mode. The second link is also dropped when the presence state of the target communication device 104 is shown as having a specific value for a specific presence attribute as described in detail earlier. The second link is dropped when a call history of the originator communication device 102, the target communication device 104, and location of at least one of the originator communication device 102 and the target communication device 104, indicates that the target communication device 104 is unlikely to answer the call. All these abovementioned criteria are similar for suspending both the first link and the second link.

When the communication link 108 is dropped, at least one the originator communication device 102 and the target communication device 104 is placed in at least one inactive state, idle state, sleep state, control hold state, the dormant state, and ready state. Placing either the originator communication device 102 or the target communication device 104 or both in one of the above mentioned state saves the capacity of the network and battery life of the either or both of the originator communication device 102 and target communication device 104. In one or more of the abovementioned states the originator communication device 102 and the target communication device 104 release the communication link 108 and some or all of their dedicated RF resources. These resources may also include Internet Protocol (IP) addresses. The ready state and the sleep state are mobile tracking states. The control hold state is the state where the channel quality/update information rate has been slowed. In this case the user still has the communication link 108 but the user cannot immediately make efficient use of the communication link 108 until the channel quality information update rate is returned to the normal higher rate.

After dropping the first link at the step 608, at step 610, a check is performed to determine when the amount of time required to render the data buffered is less than the second threshold. In an embodiment of the present invention, the check is performed by the processor 202. The second threshold is the link re-establishing threshold. In an embodiment of the present invention, the value of the second threshold is automatically adjusted to be equal to the delay required to re-establish the communication link. An exemplary value of the second link is three seconds. At step 612, the communication link 108 between the originator communication device 102 and the target communication device 104 is re-established when the time required to render the data buffered is less than the link re-establishing threshold. In an embodiment of the present invention, the communication link 108 is re-established by the channel establisher 302. Re-establishing the communication link 108 includes re-establishing a portion of the communication link 108, so as to enable communication between the originator communication device 102 and the target communication device 104. For example, re-establishing the communication link 108 may include at least re-establishing the first link or re-establishing the second link.

Further, in an embodiment of the present invention at least a portion of the communication link 108 is re-established by the channel suspender 304. In one embodiment of the present invention, a check is performed for the load on the network 106 before suspending the communication link 108. Other criteria taken into account while re-establishing the communication link 108 are Radio Frequency (RF) conditions and the battery life of both the originator communication device 102 and the target communication device 104. In another embodiment of the present invention, other criteria taken into account while re-establishing the communication link 108 includes checking the RF conditions and the battery life of the target communication device 104. The communication link 108 is re-established when the RF conditions of either the originator communication device 102 or the target communication device 104 are poor. Further, the communication link 108 is re-established when the battery life of either the originator communication device 102 or the target communication device 104 is poor. In yet another embodiment, the answering mode of the target communication device 104 and the originator communication device 102 are also checked while re-establishing the communication link 108.

In an embodiment of the present invention, an example of the first threshold is eight seconds and that of the second thresholds is three second. In this case, the communication link 108 can be a peer-to-peer link established between the originator communication device 102 and the target communication device 104. The processor 202 checks to determine whether the time required to render the data buffered is more than eight seconds. When the time required to render the data buffered is more than eight seconds, and if the originator communication device 102 has released the floor for the communication link 108, then the communication link 108 is suspended by the channel suspender 304. If the communication link 108 has been suspended, then the processor 202 checks to determine whether the time required to render the data buffered is less than three second. The communication link 108 is re-established by the channel establisher 302 when the data buffered becomes less than three second. Hence, the communication link 108 remains suspended between a timestamp of three to eight seconds. In accordance with various embodiments of the present invention, the timestamp for which the communication link 108 remains suspended may vary depending upon the software and hardware configurations of the various components associated with the network 106.

The various embodiments of the communication device and the method for managing a communication link described herein have innumerous advantages over already existing technologies for managing the communication link. The method enables an efficient use of the communication link. This is achieved by suspending the communication link when the there is no data transfer between two communication devices. The communication link is re-established when a need for call-data transfer arises. This reduces unnecessary overhead charges. Further, as the communication link is in place only when there is call data transfer, unnecessary battery consumption is saved, and overloading of the communication link is avoided. In addition, the invention improves on the channel hold time. The present invention also improves on backhaul capacity by eliminating frames across backhaul. Therefore, the backhaul capacity can be utilized for other data transfer. Additionally, the present invention improves on reverse link capacity as well as MAC ID capacity, and eliminates the need of reverse dedicated pilot. Further, admission control ensures that the user of an ongoing PTT call gets priority. The invention is especially useful for group calls, where it is not possible to notify each target communication device before sending data. In such cases, the invention helps to maintain polite interaction and eliminates forced voice data by the way it handles the manual answer mode.

It will be appreciated the communication device as described herein may be comprised of one or more conventional processors and unique stored program instructions that control the one or more processors to implement, in conjunction with certain non-processor circuits, some, most, or all of the functions of the communication device described herein. The non-processor circuits may include, but are not limited to, a radio receiver, a radio transmitter, signal drivers, clock circuits, power source circuits, and user input devices. As such, these functions may be interpreted as steps of a method to perform management of a communication link in a network. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein.

It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In this document, relational terms such as first and second, and so forth may be used solely to distinguish one entity or action from another entity or action, without necessarily requiring or implying any actual such relationship or order between such entities or actions. The terms ‘comprises,’ ‘comprising,’ or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by ‘comprises . . . a’ does not, without more constraints, preclude the existence of additional identical elements in the process, method, article, or apparatus that comprises the element.

The term ‘another’, as used herein, is defined as at least a second or more. The terms ‘including and/or ‘having’, as used herein, are defined as comprising. The term ‘program’ as used herein, is defined as a sequence of instructions designed for execution on a computer system. A ‘program’, or ‘computer program’, may include a subroutine, a function, a procedure, an object method, an object implementation, an executable application, an applet, a servlet, a source code, an object code, a shared library/dynamic load library and/or other sequence of instructions designed for execution on a computer system.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

We claim:

1. A method for managing a communication link between an originator communication device and a target communication device, the method comprising:
establishing the communication link between the originator communication device and the target communication device; and
suspending at least a portion of the communication link when the amount of time required to render data buffered outside of the originator communication device, which is for the target communication device and is not yet rendered at the target communication device, becomes greater than a first threshold and the originator communication device has released floor of the communication link, wherein the floor of the communication link gives control to a communication device for transferring data.

2. The method of claim 1 further comprising re-establishing the communication link when the amount of the time required to render the data buffered outside of the originator communication device becomes less than a second threshold when there is no new request for transferring the data.

3. The method of claim 2, wherein value the first threshold is automatically adjusted to be greater than sum of a delay required to suspend the communication link and a delay required to re-establish the communication link.

4. The method of claim 2, wherein value the second threshold is automatically adjusted to be equal to a delay required to re-establish the communication link.

5. The method of claim 2, wherein suspending at least a portion of the communication link and re-establishing at least a portion of the communication link is based on at least one of Radio Frequency (RF) conditions of the originator communication device, RF conditions of the target communication device, battery life of the originator communication device, battery life of the target communication device and load on a network, an answering mode of the originator communication device and the target communication device, wherein the originator communication device and the target communication device form a part of the network.

6. The method of claim 1, wherein suspending at least a portion of the communication link comprises dropping a first link when the originator communication device has completed uploading content of last talk burst from the originator communication device, wherein the content of the last talk burst from the originator communication device comprises the data buffered outside of the originator communication, wherein the last talk burst is initiated by the originator communication device prior to releasing the floor by the originator communication device, wherein the communication link comprises the first link between the originator communication device and a cellular infrastructure.

7. The method of claim 6, wherein suspending at least a portion of the communication link comprises dropping the first link when at least one of the following occurs:
signal strength of the first link are less than a third threshold;
remaining capacity within a sector for the originator communication device is less than a fourth threshold;
the target communication device is in a manual answer mode;
a presence state of the target communication device is shown as having a specific attribute;
a call history of the target communication device, the originator communication device and location of at least one of the originator communication device and the target communication device, indicates that the target communication device is unlikely to answer a call; and
a user of the target communication device has not pressed the accept button.

8. The method of claim 1, wherein suspending at least a portion of the communication link comprises dropping a second link when the target communication device has completed downloading content of a talk burst to the target communication device, wherein the content of the talk burst to the target communication device comprises the data buffered for the target communication device, wherein the talk burst is initiated by the originator communication device prior to releasing the floor by the originator communication device, wherein the communication link comprises the second link between a cellular infrastructure and the target communication device.

9. The method of claim 8, wherein suspending at least a portion of the communication link further comprises dropping the second link when at least one of the following occurs:
signal strength of the second link are less than a fifth threshold;
remaining capacity within a sector for the target communication device is less than a sixth threshold;
the target communication device is in a manual answer mode;
a presence state for the target communication device is shown as having a specific attribute; and
a call history of the target communication device, the originator communication device and location of at least one of the originator communication device and the target communication device, indicates that the target communication device is unlikely to answer a call.

10. The method of claim 1, wherein suspending at least a portion of the communication link comprises placing at least one of the originator communication device and the target communication device in at least one of an inactive state, an idle state, a sleep state, a dormant state, a control hold, a ready state and a mobility tracking state.

11. A communication device capable of managing a communication link between the communication device and a target communication device, the communication device comprising:
a processor capable of comparing amount of time required to render data buffered outside of the communication device, which is for the target communication device and is not yet rendered at the target communication device, with a first threshold and a second threshold; and
a channel manager operatively coupled to the processor, wherein the channel manager is capable of establishing the communication link and suspending at least a portion of a communication link in response to comparing the amount of time required to render the data buffered and when the communication device has released floor of the communication link, wherein the floor of the communication link gives control to the communication device for transferring data.

12. The communication device of claim 11 further comprising a memory for storing the content of a call.

13. The communication device of claim 11, wherein the communication link is a peer-to-peer link.

14. The communication device of claim 11, wherein the channel manager further comprises a channel establisher for establishing the communication link.

15. The communication device of claim 11, wherein the channel manager further comprises a channel suspender for suspending at least a portion of the communication link, wherein the communication link includes a first link between the communication device and a cellular infrastructure and a second link between the cellular infrastructure and the target communication device.

16. The communication device of claim 15, wherein the channel suspender suspends at least a portion of the communication link and reestablishes at least a portion of the communication link based on Radio Frequency (RF) conditions of the communication device, RF conditions of the target communication device, battery life of the communication device, battery life of the target communication device and load on a network, wherein the communication device and the target communication device form a part of the network.

17. The communication device of claim 15, wherein the channel suspender drops the first link when the communication device has completed uploading content of content of last talk burst from the originator communication e device, the content of the last talk burst is the data buffered outside of the originator communication device, wherein the last talk burst is initiated by the communication device generated prior to the communication device releasing the floor.

18. The communication device of claim 15, wherein the channel suspender drops the second link when the target communication device has completed downloading a talk burst to the target communication device, the talk burst being the data buffered for the target communication device, wherein the talk burst is initiated by the communication device prior to the communication device releasing the floor.

19. The communication device of claim 15, wherein the channel suspender drops the first link when at least one of the following occurs:
signal strength of the first link are less than a third threshold;
remaining capacity within a sector for the originator communication device is less than a fourth threshold;
the target communication device is in a manual answer mode;
a presence state of the target communication device is shown as having a specific attribute value;
a call history of the target communication device, the originator communication device and location of at least one of the originator communication device and the target communication device, indicates that the target communication device is unlikely to answer a call; and
a user of the target communication device has not pressed the accept button.

20. The communication device of claim 15, wherein the channel suspender drops the second link when at least one of the following occurs:
signal strength of the second link are less than a fifth threshold;
remaining capacity within a sector for the target communication device is less than a sixth threshold;
the target communication device is in a manual answer mode;
a presence state for the target communication device is shown as unavailable;
the presence state for the target communication device is shown as busy;
the presence state for the target communication device is shown as having a specific attribute; and
a call history of the target communication device, the originator communication device and location of at least one of the originator communication device and the target communication device, indicates that the target communication device is unlikely to answer a call.
